(19) United States
(12) Patent Application Publication
(10) Pub. No.: US 2012/0086730 A1
(43) Pub. Date: Apr. 12, 2012

(54) Method and Apparatus for Device Display Backlight

(75) Inventors: Jani E. Penttila, Lempaala (FI); Juha H. Nurmi, Salo (FI)

(73) Assignee: Nokia Corporation

(21) Appl. No.: 12/900,865

(22) Filed: Oct. 8, 2010

(51) Int. Cl. G09G 5/10

(52) U.S. Cl. 345/690

(57) ABSTRACT

In accordance with an example embodiment of the present invention, an apparatus is disclosed. The apparatus includes a power source, a power supply unit, a plurality of light emitting diodes, and a display. The power supply unit is connected to the power source. The plurality of light emitting diodes are connected to the power supply unit. A first portion of the plurality of light emitting diodes includes a connection to the power source. The connection bypasses the power supply unit. The plurality of light emitting diodes are configured to provide backlight illumination to the display when the apparatus is in a first mode. Only the first portion of the plurality of light emitting diodes is configured to provide backlight illumination to the display when the apparatus is in a second different mode.

### TECHNICAL FIELD

The invention relates to a display backlight for an electronic device.

### BACKGROUND

As electronic devices continue to become more sophisticated, these devices provide an increasing amount of functionality by including such applications as, for example, a mobile phone, digital camera, video camera, navigation system, gaming capabilities, and internet browser applications. With this increasing amount of functionality, battery life and device power consumption tend to become important considerations when for consumers when selecting a device. One area of high power consumption for electronic devices can be the display backlight when the device is in an idle (or power saving) mode.

Accordingly, as consumers demand increased functionality from electronic devices, there is a need to provide improved devices having increased capabilities, such as improved power saving, while maintaining robust and reliable product configurations.

### SUMMARY

Various aspects of examples of the invention are set out in the claims.

According to a first aspect of the present invention, an apparatus is disclosed. The apparatus includes a power source, a power supply unit, a plurality of light emitting diodes, and a display. The power supply unit is connected to the power source. The plurality of light emitting diodes are connected to the power supply unit. A first portion of the plurality of light emitting diodes includes a connection to the power source. The connection bypasses the power supply unit. The plurality of light emitting diodes are configured to provide backlight illumination to the display when the apparatus is in a first mode. Only the first portion of the plurality of light emitting diodes is configured to provide backlight illumination to the display when the apparatus is in a second different mode.

According to a second aspect of the present invention, a method is disclosed. A power source is provided. A power supply unit is connected to the power source. A plurality of light emitting diodes are connected to the power source via the power supply unit. A first portion of the plurality of light emitting diodes are connected to the power source. The connecting of the first portion of the plurality of light emitting diodes includes bypassing the power supply unit. A display is provided. The first portion of the plurality of light emitting diodes and a second portion of the plurality of light emitting diodes are configured to provide backlight illumination to the display when the apparatus is in a first mode. Only the first portion of the plurality of light emitting diodes is configured to provide backlight illumination to the display when the apparatus is in a second different mode.

According to a third aspect of the present invention, a computer program product is disclosed. The computer program product includes a computer-readable medium bearing computer program code embodied therein for use with a computer. The computer program code includes code for energizing a plurality of light emitting diodes when a device is in a first mode. The plurality of light emitting diodes is configured to receive current from a power supply unit. The power supply unit is connected between the plurality of light emitting diodes and a power source. Code for energizing only a portion of the plurality of light emitting diodes when the device is in a second different mode. The portion of the plurality of light emitting diodes is configured to receive current from the power source without connecting through the power supply unit. The light emitting diodes are configured to provide backlight illumination to a display of the device.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a schematic drawing of a display illumination system used in the device shown in FIG. 1;

FIG. 3 is a schematic drawing of another embodiment of a display illumination system used in the device shown in FIG. 1;

FIG. 4 is rotated front view of the device shown in FIG. 1;

FIG. 5 is an exemplary method of the device shown in FIG. 1; and

FIG. 6 is a schematic drawing illustrating components of the electronic device shown in FIG. 1.

### DETAILED DESCRIPTION OF THE DRAWINGS

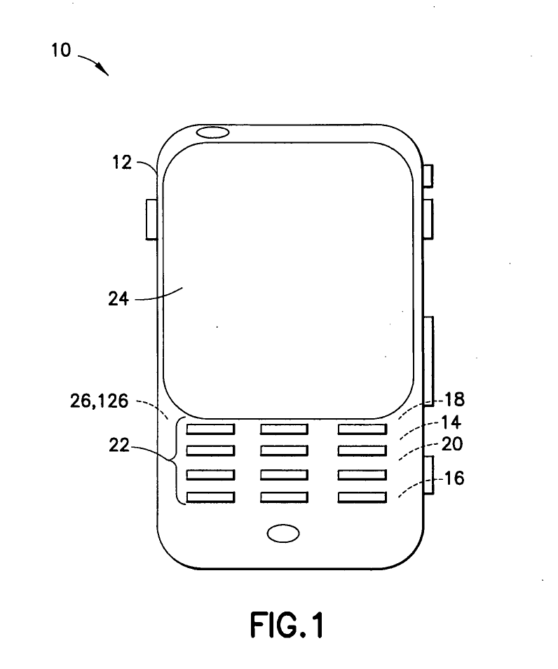

An example embodiment of the present invention and its potential advantages are understood by referring to FIGS. 1 through 6 of the drawings.

Referring to FIG. 1, there is shown a front view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention, the device 10 is a multi-function portable electronic device. However, in alternate embodiments, features of the various embodiments of the invention could be used in any suitable type of portable electronic device such as a mobile phone, a gaming device, a music player, a notebook computer, or a personal digital assistant, for example. In addition, as is known in the art, the device 10 can include multiple features or applications such as a camera, a music player, a game player, or an Internet browser, for example. The device 10 generally comprises a housing 12, a transmitter 14, a receiver 16, an antenna (connected to the transmitter 14 and the receiver 16), electronic circuitry 20, such as a controller (which could include a processor, for example) and a memory for example, within the housing 12, a user input region 22 and a display 24. The display 24 could also form a user input section, such as a touch screen. It should be noted that in alternate embodiments, the device 10 can have any suitable type of features as known in the art.

The electronic device 10 further comprises a display illumination system 26. The display illumination system 26 improves the general power efficiency of a backlight driving circuit of the device 10, and is configured to provide viewable items or information on the display 24 during the various different modes (such as different power modes, for example) of operation of the device 10.

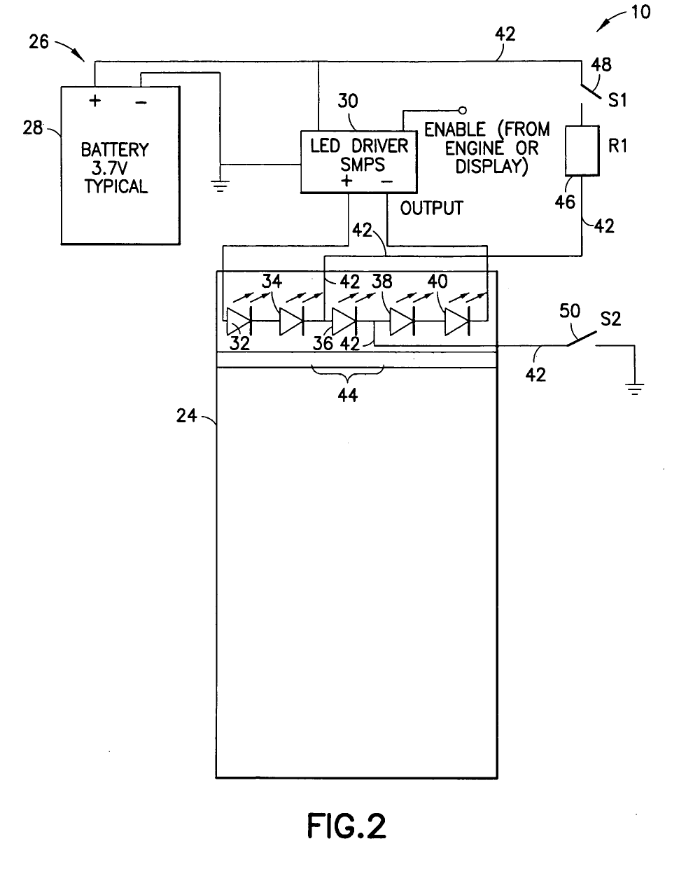

Referring now also to FIG. 2, a schematic view is shown wherein components of the display illumination system 26 are illustrated. The display illumination system 26 includes a power source (such as a battery, for example) 28, a backlight light emitting diode (LED) driver switching power supply (or switching-mode power supply [SMPS]) 30, and a chain of light emitting diodes (LED's) 32, 34, 36, 38, 40, which may be connected in series, for example. The plurality of LED's 32-40 is connected to the LED driver switching power supply 30. The switching power supply (or power supply unit) 30 provides a voltage boost to provide a higher voltage (such as a voltage greater than the output voltage of the battery 28, for example) to drive the plurality of LED's 32-40.

The chain, or plurality, of LED's 32-40 is configured to provide backlight illumination to the display 24, which may be a liquid crystal display (LCD) for example, when the device 10 is operating in a normal mode (or any mode other than an “idle” or power saving mode). It should be noted that according to some embodiments of the invention, the plurality of LED's 32-40 comprises five LED's in a series configuration, as illustrated in FIG. 2. However, in alternate embodiments, any suitable number or configuration of LED's may be provided.

The display illumination system 26 further includes a dedicated routing 42 to a portion 44 of the plurality of LED's. According to some embodiments of the invention, the portion 44 of the plurality of LED's 32-40 comprises only the single LED 36 (as shown in FIG. 2). Additionally, the portion 44 of LED's 32-40 may be provided proximate a center (or middle) section of a lightguide of the device 10. The dedicated routing 42 provides for the portion 44 of LED's to be connected directly to the battery 28, and includes a resistor 46 to limit the current flow though the portion 44 of LED's, and switches 48, 50 to turn on the portion 44 of LED's. According to some embodiments, the dedicated routing 42 is provided such that the LED 36 is between the switches 48, 50, and the resistor 46 is between the LED 36 and the battery 28. However, one skilled in the art will appreciate that any suitable dedicated routing may be provided. These auxiliary components 46, 48, 50 may be easily integrated on the display module, such as wherein the switches 48, 50 are provided on the driver integrated circuit (IC), and the resistor 46 is provided as a passive component on a display flexible printed circuit (FPC) component area. Alternatively, these components may also be located outside the display, such as on a phone printed wiring board (PWB), for example. According to other exemplary embodiments of the invention, the resistor 46 could also be integrated as part of the integrated circuit, instead of being a passive component. According to yet other exemplary embodiments of the invention, the LED devices may be controlled by using an electrical “constant current circuit”, which basically performs the same function that the simple current limiting resistor 46 performs. However, it should be noted that these are merely provided as non-limiting examples and any suitable configuration may be provided.

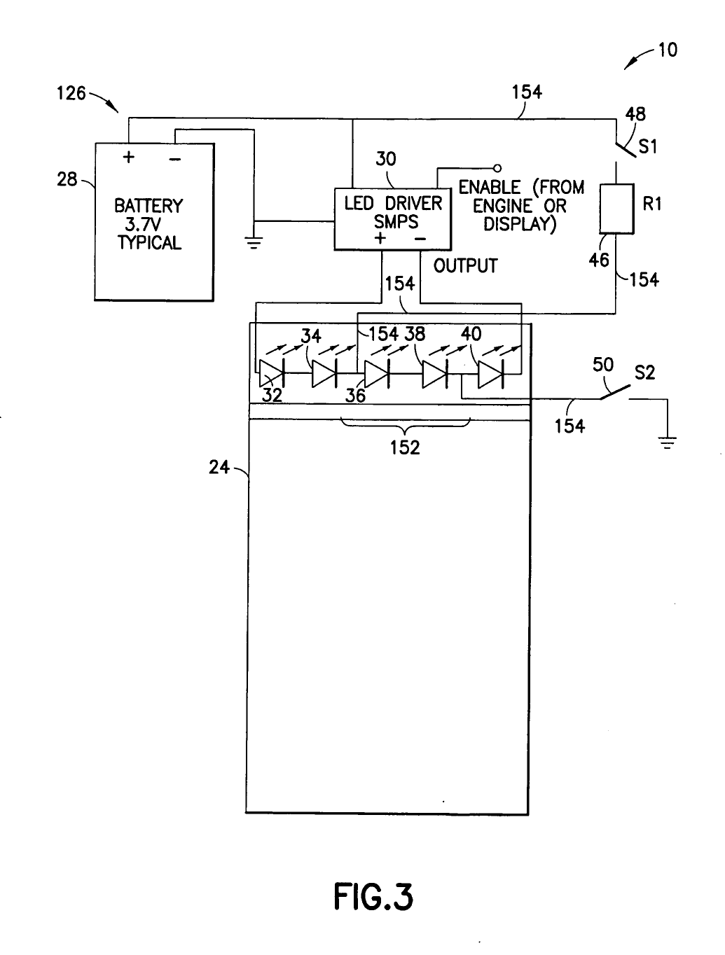

Although the dedicated routing 42 shown in FIG. 2 illustrates the portion 44 of LED's as comprising only the single LED 36, it should be noted that according to other embodiments of the invention, a display illumination system 126 may comprise a portion 152 of the plurality of LED's 32-40 may comprise the LED's 36, 38 (as shown in FIG. 3). Similarly as described above, the portion 152 of the LED's may be provided proximate the center (or middle) section of the lightguide of the device 10, the LED's 36, 38 may be connected directly to the battery 28 by a dedicated routing 154 comprising the switches 48, 50, and the resistor 46 to control the current flow through the LED's 36, 38. However, in yet other embodiments, the portion of the plurality of LED's may comprise any suitable number of LED's.

According to some examples of the invention, the display illumination system 26, 126 may be controlled automatically via the display driver electronics such that when a “lo power idle mode on” command is issued, the normal backlight (comprising the entire plurality of the LED's 32-40, for example) will be shut down, and the display will automatically be lit (or illuminated) with the portion 44, 152 of the plurality of LED's through the dedicated routing 42, 154 with very low current.

The dedicated routing 42, 154 allows for the device 10 to provide a display backlight (or backlight illumination) while operating with low power consumption, such as during an idle (or power saving) mode wherein instead of using all of the plurality of LED's 32-40 of the display to light up the backlight, only the portion 44, 152 of the plurality of LED's is selected and connected directly to the battery 28 (or similar efficient power supply) in a simple manner. This allows for using a small number (such as the portion 44, 152) of LED's such that the voltage boosting circuit (including the power supply unit 30) is not needed (thus providing low power consumption).

Although the dedicated routing 42, 154 provides for the LED(s) 36, 38 to bypass the power supply unit 30 and have a direct connection to the battery 28, it should be noted that, in some alternate embodiments of the invention, the dedicated routing may provide for the LED to have a direct connection to an alternative power supply, such as another battery for example. It should further be noted that although a switching-mode power supply (or power supply unit) 30 is described above, alternate embodiments of the invention may comprise any suitable type of electronic power supply unit that incorporates a switching regulator in order to provide the required output voltage. Additionally, according to some exemplary embodiments of the invention, such as in laptop computer application, the battery voltage of the device may be so high that a linear regulator may be provided instead of the power supply unit 30. However, any suitable configuration may be provided.

According to various exemplary embodiments of the invention a configuration and/or method is provided for energizing only the portion 44, 152 of the plurality of LED's (such that the portion comprises one or more of the plurality LED's, without energizing the entire plurality of LED's 32-40) to provide the display backlight (or backlight illumination for the device). The energized portion 44, 152 of LED's may provide, for example, backlight illumination for displaying items such as an “always on” clock, “missed call” indication, or “incoming SMS” type indication. The energized portion 44, 152 of LED's provides some light to the backlight in a way that the user of the device 10 sees that ‘something is happening’ (such as a missed call or message, for example) while the power level of the backlight is kept to a reasonable (or substantially low) level. This is provided by keeping the number of energized LED's low (such as only energizing the LED 36, or only energizing the LED's 36, 38, when the device is in the power saving, or ‘idle’, mode). For example, if too many LED's are energized when in the ‘idle’ mode, the voltage boosting power supply unit 30, which generally has poor efficiency, will need to be enabled. As described above, various exemplary embodiments of the invention provide a simple circuit, wherein the portion 44, 152 of LED's is connected directly to the device battery (while bypassing the power supply unit).

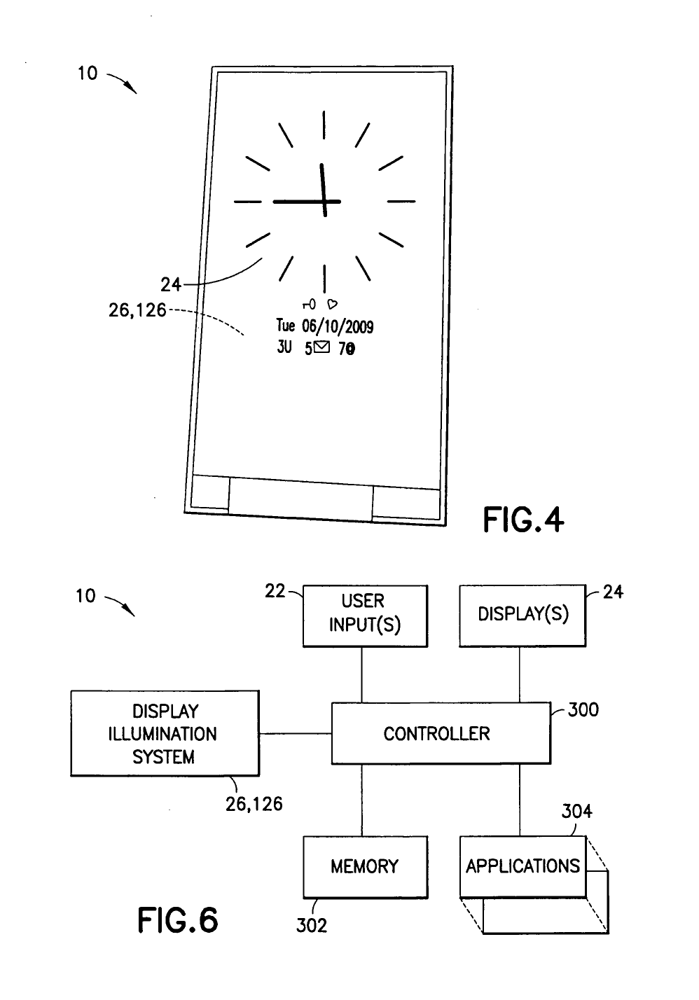

Referring now also to FIG. 4, the device 10 is shown in an ‘idle’ (or power saving) mode wherein the portion 44, 152 of the plurality of LED's 32-40 provides a dimmed backlight. The display illumination system 26, 126 provides for suitable image visibility in office conditions when the device 10 is in the power saving mode. For example, according to some embodiments of the invention, each LED is generally provided with a current of about 2 mA. Therefore with embodiments of the invention wherein the dedicated routing provides a direct connection for two LED's to the battery (such as the portion 152), the power consumption (by the backlight) would be about 14 mW (2×3.5V×2 mA). With embodiments of the invention wherein the dedicated routing provides a direct connection for a single LED to the battery (such as the portion 44), the power consumption (by the backlight) would be about 5 mW to about 7 mW. However, the portion of the LED's may comprise any suitable number of LED's (and corresponding current/power levels).

While the figures illustrate the portion 44, 152 (and the plurality) of LED's 32-40 proximate a top end of the display 24, one skilled in the art will appreciate that the various exemplary embodiments of the invention are not necessarily so limited and that any suitable location of the portion and/or plurality of LED's may be provided. For example, the suitable location of the portion and/or plurality of LED's may be provided based on considerations such as the different luminance of areas close to, and at a distance from, the portion of LED's (as the uniformity of the luminance of the display may be limited due to only the portion of LED's energized). It should further be noted that by using a content that compensates the known limited uniformity (for example, if the LED is placed on left corner of display, it is causing the display to be more bright on the left than on the right side), if we use an image the is darker on the left side and has brighter content on the right side, the end result provides for a substantially quite uniform image. According to some exemplary embodiments, this may also be provided by using a customized light guide and/or optical sheet structure in circumstance of this LED, around portion 44, to improve the uniformity. According to some exemplary embodiments, this may also be provided by using customized location for this LED around portion 44, to improve the uniformity. According to some exemplary embodiments, this may also be provided by using an LED device that is such a type, that it emits light in wider angle compared to “normal” LED's. Additionally, it should be understood that the descriptions above, such as the “left side” and “right side” examples, are merely exemplary and any suitable orientations may be provided.

Additionally, according to some exemplary embodiments of the invention more than one dedicated routing may be provided wherein each one of the dedicated routings corresponds to a different portion of the plurality of LED's, and wherein the different portions of the LED's are disposed at different areas/sections of the display. This allows for energizing a particular LED where the information is needed. Such as, if a missed call icon is located proximate an upper right corner of the display, then the display illumination system could be configured to provide a direct connection to the corresponding LED (through activated switches proving a dedicated routing) proximate the upper right hand corner of the display. This would provide for only the portion of LED's to be energized such that the icon is illuminated. Similarly, if information (such as a text message indication, for example) is to be shown in middle of the screen, then the display illumination system is configured to provide another direct connection to the corresponding LED (through activated switches proving another dedicated routing) proximate the center/middle area of the display. This would provide for only the portion of LED's to be energized such that the icon is illuminated.

FIG. 5 illustrates a method 200. The method 200 includes providing a power source (at block 202). Connecting a power supply unit to the power source (at block 204). Connecting a plurality of light emitting diodes to the power source via the power supply unit (at block 206). Connecting a first portion of the plurality of light emitting diodes to the power source, wherein the connecting of the first portion of the plurality of light emitting diodes comprises bypassing the power supply unit (at block 208). Providing a display, wherein the first portion of the plurality of light emitting diodes and a second portion of the plurality of light emitting diodes are configured to provide backlight illumination to the display when the apparatus is in a first mode, and wherein only the first portion of the plurality of light emitting diodes is configured to provide backlight illumination to the display when the apparatus is in a second different mode (at block 210). It should be noted that the illustration of a particular order of the blocks does not necessarily imply that there is a required or preferred order for the blocks and the order and arrangement of the blocks may be varied. Furthermore it may be possible for some blocks to be omitted.

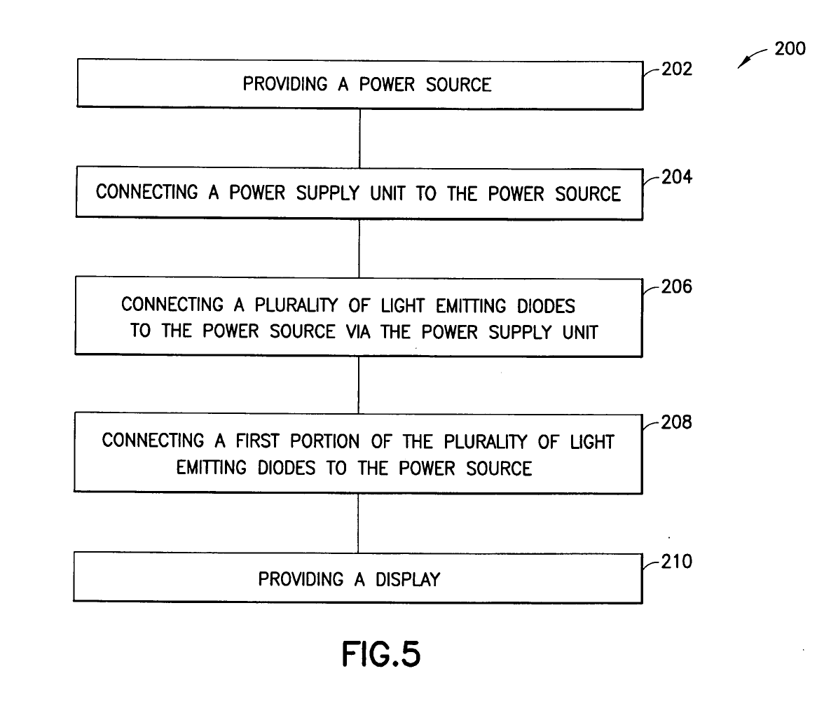

Referring now also to FIG. 6, the device 10 generally comprises a controller 300 such as a microprocessor for example. The electronic circuitry includes a memory 302 coupled to the controller 300, such as on a printed circuit board for example. The memory could include multiple memories including removable memory modules for example. The device has applications 304, such as software, which the user can use. The applications can include, for example, a telephone application, an Internet browsing application, a game playing application, a digital camera application, a map/gps application. These are only some examples and should not be considered as limiting. One or more user inputs 22 are coupled to the controller 300 and one or more displays 24 are coupled to the controller 300. The display illumination system 26, 126 is also coupled to the controller 300. The device 10 may programmed to automatically energize a plurality of light emitting diodes when a device is in a first mode (such as a normal operating mode, for example), and automatically energize only a portion of the plurality of light emitting diodes when the device is in a second different mode (such as an idle or power saving mode).

It should be noted that although the figures and description provide for five light emitting diodes 32-40 proximate the display 24 of the device 10, other suitable configurations may be provided. For example, according to some example embodiments of the invention, the display illumination system may comprise about 4 to about 10 LED's. However, the plurality of LED's may comprise any suitable number of LED's. Additionally, some of the LED's may be provided proximate other sections of the device, such as proximate a keypad, a switch, a second display (or touch screen display), a user input region, or any other suitable device feature.

Without in any way limiting the scope, interpretation, or application of the claims appearing below, a technical effect of one or more of the example embodiments disclosed herein is overcoming the complexity of using external backlight drive in idle mode. Another technical effect of one or more of the example embodiments disclosed herein is increasing the power efficiency to be able to provide the end user with an improved user experience wherein screen content is visible when the phone is in power save mode. Another technical effect of one or more of the example embodiments disclosed herein is that the display could automatically arrange the connection to utilize only the portion of LED's (such as only one single LED, for example) when the idle mode entry command is issued. Additionally, a technical effect of providing the portion of LED's as only a single LED that a single LED is substantially applicable to many existing battery voltages.

According to various exemplary embodiments of the invention, a method and apparatus for saving the liquid crystal display backlight power, in mobile handsets for example, is provided. Various exemplary embodiments provide for implementing the power supply for display illumination purposes, and to enable power efficient usage of display backlight illumination in some use cases. For example, power efficient usage may be provided for uses cases such as “idle mode screen” or “always visible home screen” where the device is generally in a power save/saving mode, idle mode, or other suitable mode.

Many conventional devices having liquid crystal displays use so called “transmissive” technology, wherein a backlight is generally required in order to see images on the display. The backlight (generally comprising light emitting diodes and a lightguide) is one of the major contributors to display (and entire device) power consumption, as conventional backlights generally have all of the light emitting diodes energized during all backlight use cases. Due to the excessive power consumption of the backlight, conventional configurations generally cannot use the backlight (such as for showing a calendar, time, or missed calls, for example) when the device is in an idle mode (as conventional backlights generally have power consumption levels on the order of about 100's of mW).

Technical effects of any one or more of the exemplary embodiments provide improvements over conventional configurations having a backlight drive circuit adapted only for energizing the entire plurality of LED's through the voltage boosting power supply unit (or voltage boosting circuit). A technical effect of one or more of the example embodiments is an improved display illumination system as LCD displays generally tend to have backlight LED's connected in series. A large voltage is generally used to drive the LED's in a series connection, as the threshold voltage of a single LED about 3 or more volts. Generation of this high voltage needs a boost type switching power supply, the efficiency of which is not optimum at light loads. Due to this, conventional configurations normally shut down the LCD display completely when power saving or so called idle mode is on (as too much power can be drained by using the voltage boosting power supply).

Technical effects of any one or more of the exemplary embodiments provide improvements over conventional configurations having so called transflective displays, which have other optical properties and cost sacrificed in a way that backlight is not needed at all to show the idle mode image, and conventional configurations having the normal backlight driving circuit and merely drops the current to very low level. A technical effect of one or more of the example embodiments is providing a backlight drive circuit that provides for various indications (such as message statuses, for example) on the display while in idle or power save mode by utilizing only a single LED, or a portion of the LED's (such as, at least less LED's than exist in the LCD backlight during normal use, for example) to provide backlight illumination with lower power consumption.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the electronic device 10 (such as on the memory 302, or another memory of the device), on a server, or any other suitable location. If desired, part of the software, application logic and/or hardware may reside on device, and part of the software, application logic and/or hardware may reside on the server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, an apparatus is disclosed. The apparatus comprises a power source, a power supply unit, a plurality of light emitting diodes, and a display. The power supply unit is connected to the power source. The plurality of light emitting diodes is connected to the power supply unit. A first portion of the plurality of light emitting diodes comprises a connection to the power source. The connection bypasses the power supply unit. The plurality of light emitting diodes are configured to provide backlight illumination to the display when the apparatus is in a first mode. Only the first portion of the plurality of light emitting diodes is configured to provide backlight illumination to the display when the apparatus is in a second different mode.

An apparatus as above, wherein the second mode is a power saving mode.

An apparatus as above, wherein the first portion of the plurality of light emitting diodes comprises a dedicated routing to the power source.

An apparatus as above, wherein the power source is a battery and the power supply unit is a switching-mode power supply unit.

An apparatus as above, wherein the first portion of the plurality of light emitting diodes comprises a single light emitting diode.

An apparatus as above, wherein the first portion of the plurality of light emitting diodes is configured to provide backlight illumination to the display for indicating a time of day, a date, a missed call, or a message. However, these are provided as non-limiting examples, and the plurality of light emitting diodes may also be configured to provide backlight illumination to the display for indicating a map location, an RSS feed, or any suitable content.

An apparatus as above, wherein the first portion of the plurality of light emitting diodes comprises a direct connection to the power source.

An apparatus as above, wherein the first portion of the plurality of light emitting diodes is configured for applicable low power consumption when providing backlight illumination to the display when the apparatus is in the second mode.

An apparatus as above, wherein the apparatus comprises a mobile phone.

In one exemplary embodiment, the method 200 as described above wherein the connecting of the plurality of light emitting diodes to the power source via the power supply unit further comprises connecting the plurality of light emitting diodes in series.

In one exemplary embodiment, the method 200 as described above wherein only the first portion of the plurality of light emitting diodes is configured to provide backlight illumination to the display when the apparatus is in a power saving mode.

In one exemplary embodiment, the method 200 as described above wherein the first portion of the plurality of light emitting diodes comprises a single light emitting diode.

In one exemplary embodiment, the method 200 as described above wherein the providing of the power source further comprises providing a battery, and wherein the connecting of the power supply unit to the power source further comprises connecting a switching-mode power supply unit to the battery.

In one exemplary embodiment, the method 200 as described above wherein the first portion of the plurality of light emitting diodes and the second portion of the plurality of light emitting diodes comprises the entire plurality of light emitting diodes.

In one exemplary embodiment, the method 200 as described above wherein the connecting of the first portion of the plurality of light emitting diodes to the power source further comprises providing a dedicated routing between the first portion and the power source.

In one exemplary embodiment, the method 200 as described above wherein the connecting of the first portion of the plurality of light emitting diodes to the power source further comprises connecting a resistor and a switch between the first portion of the plurality of light emitting diodes and the power source.

In one exemplary embodiment, a computer program product comprising a computer-readable medium bearing computer program code embodied therein for use with a computer is disclosed. The computer program code comprises code for energizing a plurality of light emitting diodes when a device is in a first mode. The plurality of light emitting diodes is configured to receive current from a power supply unit. The power supply unit is connected between the plurality of light emitting diodes and a power source. Code for energizing only a portion of the plurality of light emitting diodes when the device is in a second different mode. The portion of the plurality of light emitting diodes is configured to receive current from the power source without connecting through the power supply unit. The light emitting diodes are configured to provide backlight illumination to a display of the device.

A computer program product as above further comprising code for energizing only the portion of the plurality of light emitting diodes when the device is in a power saving mode, wherein the portion of the plurality of light emitting diodes is configured to bypass a switching-mode power supply unit and receive current directly from a battery.

A computer program product as above wherein the code for energizing only the portion of the plurality of light emitting diodes when the device is in the second mode comprises energizing only a single one of the plurality of light emitting diodes.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a power source;
a power supply unit connected to the power source;
a plurality of light emitting diodes connected to the power supply unit, wherein a first portion of the plurality of light emitting diodes comprises a connection to the power source, and wherein the connection bypasses the power supply unit; and
a display, wherein the plurality of light emitting diodes are configured to provide backlight illumination to the display when the apparatus is in a first mode, and wherein only the first portion of the plurality of light emitting diodes is configured to provide backlight illumination to the display when the apparatus is in a second different mode.

2. An apparatus as in claim 1 wherein the second mode is a power saving mode.

3. An apparatus as in claim 1 wherein the first portion of the plurality of light emitting diodes comprises a dedicated routing to the power source.

4. An apparatus as in claim 1 wherein the power source is a battery and the power supply unit is a switching-mode power supply unit.

5. An apparatus as in claim 1 wherein the first portion of the plurality of light emitting diodes comprises a single light emitting diode.

6. An apparatus as in claim 1 wherein the first portion of the plurality of light emitting diodes is configured to provide backlight illumination to the display for indicating a time of day, a date, a missed call, or a message.

7. An apparatus as in claim 1 wherein the first portion of the plurality of light emitting diodes comprises a direct connection to the power source.

8. An apparatus as in claim 1 wherein the first portion of the plurality of light emitting diodes is configured for about 5 mW to about 7 mW of power consumption when providing backlight illumination to the display when the apparatus is in the second mode.

9. An apparatus as in claim 1 wherein the apparatus comprises a mobile phone.

10. A method, comprising:
providing a power source;
connecting a power supply unit to the power source;
connecting a plurality of light emitting diodes to the power source via the power supply unit;
connecting a first portion of the plurality of light emitting diodes to the power source, wherein the connecting of the first portion of the plurality of light emitting diodes comprises bypassing the power supply unit; and
providing a display, wherein the first portion of the plurality of light emitting diodes and a second portion of the plurality of light emitting diodes are configured to provide backlight illumination to the display when the apparatus is in a first mode, and wherein only the first portion of the plurality of light emitting diodes is configured to provide backlight illumination to the display when the apparatus is in a second different mode.

11. A method as in claim 10 wherein the connecting of the plurality of light emitting diodes to the power source via the power supply unit further comprises connecting the plurality of light emitting diodes in series.

12. A method as in claim 10 wherein only the first portion of the plurality of light emitting diodes is configured to provide backlight illumination to the display when the apparatus is in a power saving mode.

13. A method as in claim 10 wherein the first portion of the plurality of light emitting diodes comprises a single light emitting diode.

14. A method as in claim 10 wherein the providing of the power source further comprises providing a battery, and wherein the connecting of the power supply unit to the power source further comprises connecting a switching-mode power supply unit to the battery.

15. A method as in claim 10 wherein the first portion of the plurality of light emitting diodes and the second portion of the plurality of light emitting diodes comprises the entire plurality of light emitting diodes.

16. A method as in claim 10 wherein the connecting of the first portion of the plurality of light emitting diodes to the power source further comprises providing a dedicated routing between the first portion and the power source.

17. A method as in claim 10 wherein the connecting of the first portion of the plurality of light emitting diodes to the power source further comprises connecting a resistor and a switch between the first portion of the plurality of light emitting diodes and the power source.

18. A computer program product comprising a computer-readable medium bearing computer program code embodied therein for use with a computer, the computer program code comprising:
code for energizing a plurality of light emitting diodes when a device is in a first mode, wherein the plurality of light emitting diodes is configured to receive current from a power supply unit, and wherein the power supply unit is connected between the plurality of light emitting diodes and a power source; and
code for energizing only a portion of the plurality of light emitting diodes when the device is in a second different mode, wherein the portion of the plurality of light emitting diodes is configured to receive current from the power source without connecting through the power supply unit;
wherein the light emitting diodes are configured to provide backlight illumination to a display of the device.

19. A computer program product as in claim 18 further comprising code for energizing only the portion of the plurality of light emitting diodes when the device is in a power saving mode, wherein the portion of the plurality of light emitting diodes is configured to bypass a switching-mode power supply unit and receive current directly from a battery.

20. A computer program product as in claim 18 wherein the code for energizing only the portion of the plurality of light emitting diodes when the device is in the second mode comprises energizing only a single one of the plurality of light emitting diodes.
